(19) United States
(12) Patent Application Publication
(10) Pub. No.: US 2026/0237923 A1
(43) Pub. Date: Aug. 13, 2026

(54) CABLE ASSEMBLY

(71) Applicant: BIZLINK INTERNATIONAL CORP., New Taipei City (TW)

(72) Inventors: Jui-Hung CHIEN, New Taipei City (TW); Guang Zong HU, New Taipei City (TW); Chien-Hua CHIU, New Taipei City (TW)

(21) Appl. No.: 19/048,957

(22) Filed: Feb. 9, 2025

(51) Int. Cl. H01R 12/71

(52) U.S. Cl. CPC H01R 12/716

(57) ABSTRACT

A cable assembly includesa plug, a circuit board module, a terminal holder, a first cable set, and a second cable set. The circuit board module includes a circuit board and a connecting port electrically connected to the circuit board. The terminal holder is disposed on the circuit board. The terminal holder includes a long groove and a short groove. A first terminal set and a second terminal set are disposed therein. A third terminal set is disposed therein. The first cable set includes a first cable is connected between the first terminal set and the plug. The second cable set includes a transition board, a second cable, and a third cable. The second cable electrically connects the second terminal set to the transition board. The third cable electrically connects the transition to the plug.

### BACKGROUND

Field of Invention

The present invention relates to a cable assembly.

### Description of Related Art

Due to CEM (COM Express Module) pin definition, low-speed signals are also included, except for high-speed signals. Generally, the high speed signals and the low speed signals are transmitted via traces on a circuit board. Sometimes, the low-speed signals are further needed to pass through the electrical component. The low speed signals pass through the electrical component which is surface-mounted (e.g., SMT) on the circuit board via the traces, and the traces transfer the low speed signals through a raw cable to another plug. However, the problem of PCB loss leads to more increased resistance, thereby deteriorating the electrical performance of whole cable assembly.

How to propose a cable assembly that can solve the aforementioned problems is one of the problems that the industry is currently eager to invest in research and development resources to solve.

### SUMMARY

In view of this, one purpose of the present disclosure is to provide a cable assembly that can solve the aforementioned problems.

In order to achieve the above objective, according to an embodiment of the present disclosure, a cable assembly includes a plug, a circuit board module, a terminal holder, a first cable set, and a second cable set. The circuit board module includes a circuit board and a connecting port electrically connected to the circuit board. The terminal holder is disposed on the circuit board. The terminal holder includes a long groove and a short groove. A first terminal set and a second terminal set are disposed therein. A third terminal set is disposed therein. The first cable set includes a first cable is connected between the first terminal set and the plug. The second cable set includes a transition board, a second cable, and a third cable. The second cable electrically connects the second terminal set to the transition board. The third cable electrically connects the transition to the plug.

### BRIEF DESCRIPTION OF THE DRAWINGS

The invention can be more fully understood by reading the following detailed description of the embodiment, with reference made to the accompanying drawings as follows:

FIG. 1 is a perspective view of a cable assembly in accordance with an embodiment of the present disclosure;

FIG. 2 is a sided view of the cable assembly in accordance with an embodiment of the present disclosure; and

FIG. 3 is a cross-sectional view of the cable assembly based on a section A-A′ of the FIG. 2 in accordance with an embodiment of the present disclosure.

### DETAILED DESCRIPTION

Hereinafter, a plurality of embodiments of the present disclosure will be disclosed in diagrams. For the sake of clarity, many details in practice will be described in the following description. However, it should be understood that these details in practice should not limit present disclosure. In other words, in some embodiments of present disclosure, these details in practice are unnecessary. In addition, for simplicity of the drawings, some conventionally used structures and elements will be shown in a simple schematic manner in the drawings. The same reference numbers are used in the drawings and the description to refer to the same or like parts.

Hereinafter, the structure and function of each component included in the cable assembly 100 of this embodiment and the connection relationship between the components will be described in detail.

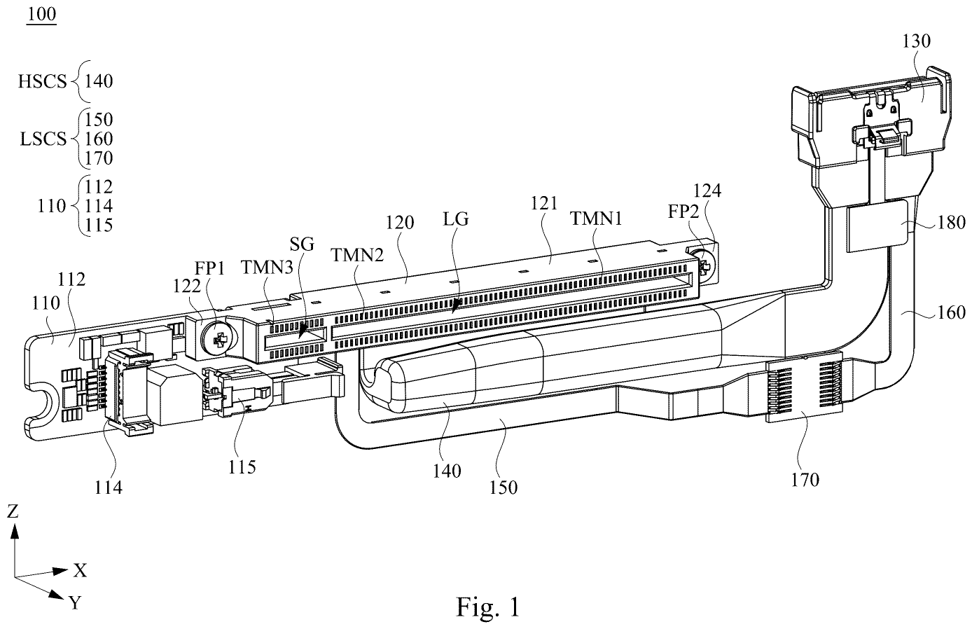

Reference is made to FIG. 1. FIG. 1 is a perspective view of a cable assembly 100 in accordance with an embodiment of the present disclosure. As shown in FIG. 1, in this embodiment, the cable assembly 100 includes a circuit board module 110, a terminal holder 120, a plug 130, a first terminal set TMN1, a second terminal set TMN2, a third terminal set TMN3, a high speed cable set HSCS, a low speed cable set LSCS, and a pull tab 180. The circuit board module 110 includes a circuit board 112, a connecting port 114, and a connecting port 115. The connecting port 114 and the connecting port 115 are electrically connected to the circuit board 112. The terminal holder 120 is disposed on the circuit board 112. The terminal holder 120 includes a main body 121, a first end portion 122, and a second end portion 124. The terminal holder 120 further has a long groove LG and a short groove SG recessed from the main body 121. The long groove LG is separated from the short groove SG. In some embodiments, the long groove LG and the short groove SG are configured to allow a riser card (not depicted) to insert. The first end portion 122 and the second end portion 124 are located on opposite sides of the terminal holder 120. Specifically, the first end portion 122 and the second end portion 124 are located on both ends of the main body 121. The long groove LG and the short groove SG are located between the first end portion 122 and the second end portion 124. In some embodiments, the short groove SG is located at a side of the terminal holder 120 close to the first end portion 122 and the long groove LG is located at a side of the terminal holder 120 close to the second end portion 124. The first end portion 122 is fixed on the circuit board 112 by a fixing part FP1, whereas the second end portion 124 is not connected with the circuit board 112. In some embodiments, a fixing part FP2 is disposed and fixed on the second end portion 124. In some other embodiments, the second end portion 124 may also be fixed on the circuit board 112 by the fixing part FP2.

In some embodiments, the long groove LG and the short groove SG are elongated in a direction (e.g., x-direction). In some embodiments, the long groove LG and the short groove SG are recessed along a direction (e.g., y-direction).

In some embodiments, the terminal holder 120 may be made of insulating material. In some embodiments, the terminal holder 120 may be made of, for example, plastic or other suitable insulating material.

Reference is made again to FIG. 1. As shown in FIG. 1, in this embodiment, the first terminal set TMN1 and the second terminal set TMN2 are embedded in the long groove LG. Specifically, the cable assembly 100 may further include a plurality of ground terminals (not depicted). The first terminal set TMN1 and the second terminal set TMN2 respectively include a plurality of first terminals and a plurality of second terminals (not depicted). In some embodiments, one of the first terminals, one of the second terminals, and one of the ground terminals are alternatively arranged in the long groove LG. The third terminal set TMN3 is embedded in the short groove SG. The third terminal set TMN3 is electrically connected to the circuit board 112. Specifically, the third terminal set TMN3 is soldered on the circuit board 112. In some embodiments, the first terminal set TMN1 includes high speed signal terminals. In some embodiments, the second terminal set TMN2 and the third terminal set TMN3 include low speed signal terminals. The long groove LG is configured to secure the high speed signal terminals of the first terminal set TMN1 and the low speed signal terminals of the second terminal set TMN2. The short groove SG is configured to secure the low speed signal terminals of the third terminal set TMN3.

Reference is made again to FIG. 1. As shown in FIG. 1, in this embodiment, the plug 130 is not connected from the terminal holder 120. The high speed cable set HSCS includes a first cable 140. The low speed cable set LSCS includes a second cable 150, a third cable 160, and a transition board 170. The first cable 140 is connected between the first terminal set TMN1 and the plug 130. Specifically, an end of the first cable 140 is soldered to the first terminal set TMN1. The transition board 170 is not connected to the terminal holder 120 and the plug 130. The second cable 150 is connected between the second terminal set TMN2 and the transition board 170. Specifically, an end of the second cable 150 is soldered to the second terminal set TMN2, and the other end of the second cable 150 is soldered to the transition board 170. The third cable 160 is connected between the transition board 170 and the plug 130. Specifically, an end of the third cable 160 is soldered to the transition board 170. In some embodiments, the first cable 140 is high speed signal cable and configured to transmit high speed signals. In some embodiments, the second cable 150 and the third cable 160 are low speed signal cables configured to transmit low speed signals. The transition board 170 includes electrical component (not depicted) configured to process the low speed signals. In some embodiments, the electrical component is surface-mounted (e.g., SMT) on the transition board 170. The pull tab 180 is disposed on the plug 130. In some embodiments, the electrical component includes, for example, a plurality of chips for computing.

In a usage scenario, as the riser card insert into the long groove LG and the short grove SG, the high speed signals from the riser card are transmitted via the first terminal set TMN1 to the first cable 140, and the low speed signals from the riser card are transmitted via the second terminal set TMN2 to the second cable 150 and via the third terminal set TMN3 to the circuit board 112. Next, the high speed signals are transmitted via the first cable 140 to the plug 130. The low speed signals in the second cable 150 pass through the transition board 170, and the low speed signals are processed by the electrical component of the transition board 170, then transmitted to the plug 130 via the third cable 160. The low speed signals from the third terminal set TMN3 are transmitted via the circuit board 112 to the connecting port 114 and the connecting port 115.

By the aforementioned structural configuration, since the transition board 170 includes the electrical component, the space of the circuit board module 110 may be reduced, such that the first cable 140 and the second cable 150 can be directly connected to the first terminal set TMN1 and the second terminal set TMN2 without interfering with the circuit board 112.

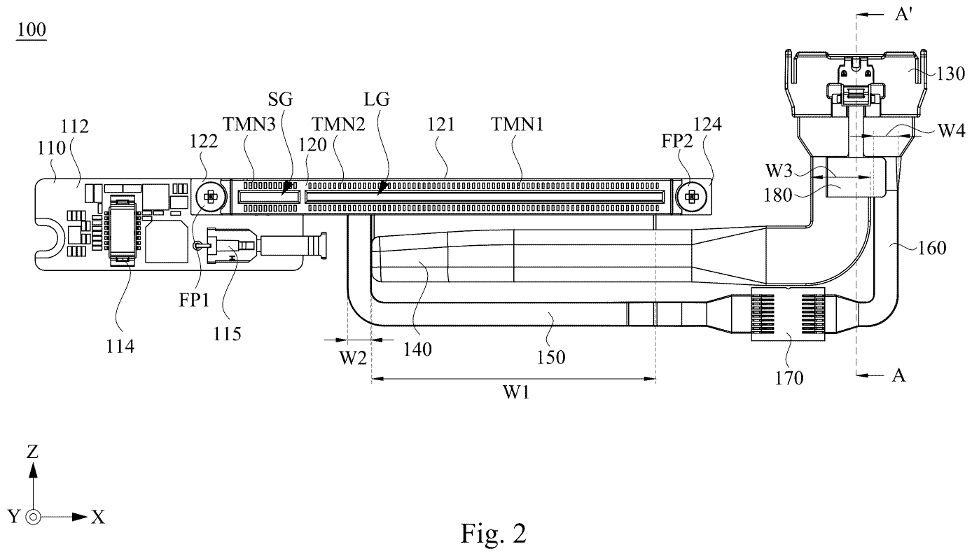

Reference is made to FIG. 2. FIG. 2 is a sided view of the cable assembly 100 in accordance with an embodiment of the present disclosure. As shown in FIG. 2, in this embodiment, in a sided view, the short groove SG is located in an area of the circuit board 112 extended on an x-z plane. This ensures the third terminal set TMN3 can directly contact the circuit board 112. The long groove LG and the second end portion 124 protrude outward from the circuit board 112. In the sided view, the long groove LG and the second end portion 124 are not located in the area of the circuit board 112 extended on the x-z plane. In other words, the first terminal set TMN1 and the second terminal set TMN2 neither in direct contact with the circuit board 112 nor be directly electrically connected thereto by welding or other means. The first terminal set TMN1 and the second terminal set TMN2 do not contact with the circuit board 112, while the third terminal set TMN3 is in contact with the circuit board 112. The first cable 140 and the second cable 150 are not connected to the circuit board module 110.

Reference is made again to FIG. 2. As shown in FIG. 2, in this embodiment, an end of the first cable 140 is connected to the first terminal set TMN1 embedded in the long groove LG, and the other end of the first cable 140 is connected to the plug 130. The first cable 140 has a width W1 on an end of the first cable 140 connected to the first terminal set TMN1 and a width W3 on an end of the first cable 140 connected to the plug 130. In other words, the width W1 is also a width of an end of the high speed cable set HSCS connected to the first terminal set TMN1, and the width W3 is also a width of an end of the high speed cable set HSCS connected to the plug 130. The second cable 150 has a width W2 on an end of the second cable 150 connected to the second terminal set TMN2. The third cable 160 has a width W4 on an end of the third cable 160 connected to the plug 130. In other words, the width W2 is also a width of an end of the low speed cable set LSCS connected to the second terminal set TMN2, and the width W4 is also a width of an end of the low speed cable set LSCS connected to the plug 130.

In some embodiments, the width W1 is greater than the width W2. Specifically, a quantity of the conductive terminals of the first terminal set TMN1 is greater than a quantity of the conductive terminals of the second terminal set TMN2, so that the space occupied by the first terminal set TMN1 in the terminal holder 120 is larger than the space occupied by the second terminal set TMN2 in the terminal holder 120. Therefore, the width W1 is preferably greater than the width W2. In some embodiments, the width W3 is greater than the width W4. Specifically, the first cable 140 includes more wires to carry relatively larger current, the second cable 150 and the third cable 160 include fewer wires to carry relatively small current, so that the space occupied by the first cable 140 in the plug 130 is larger than the space occupied by the third cable 160 in the plug 130. Therefore, the width W3 is preferably greater than the width W4. In some embodiments, the width W1 is greater than the width W3.

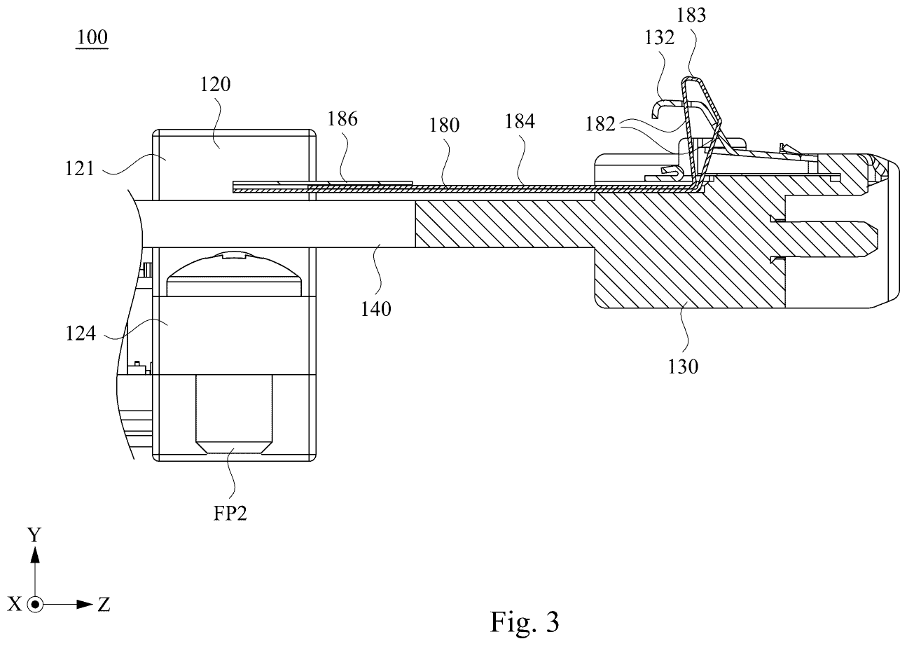

Reference is made to FIG. 3. FIG. 3 is a cross-sectional view of the cable assembly 100 based on a section A-A′ of the FIG. 2 in accordance with an embodiment of the present disclosure. As shown in FIG. 3, in this embodiment, the plug 130 includes an elastic arm 132. The elastic arm 132 extends from a surface of the plug 130. In some embodiments, the elastic arm 132 protrudes from the plug 130 toward a direction (e.g., y-direction). Specifically, the elastic arm 132 has a fixed end and a free end. The fixed end of the elastic arm 132 is connected to the plug 130, and the free end of the elastic arm 132 is suspended relative to the plug 130. As shown in FIG. 3, in some embodiments, a first portion of the elastic arm 132 is extended from the fixed end of the elastic arm 132 along z-direction, and then a second portion of the elastic arm 132 is extended along another direction inclined to and away from the surface of the plug 130. Finally, a third portion of the elastic arm 132 is extended in z-direction to the free end of the elastic arm 132. In some embodiments, a distance between the third portion of the elastic arm 132 and the surface of the plug 130 is greater than a distance between the first portion of the elastic arm 132 and the surface of the plug 130. In a usage scenario, as the plug 130 inserts into a port (not depicted), the second portion and the third portion of the elastic arm 132 interfere with the port.

Reference is made again to FIG. 3. As shown in FIG. 3, in this embodiment, the pull tab 180 is connected to the elastic arm 132. The pull tab 180 includes a ring portion 182, an elongated portion 184, and a tab portion 186. The ring portion 182 is attached to the elastic arm 132. The ring portion 182 includes a blocking portion 183. The blocking portion 183 is located at a side away from the plug 130. Specifically, the ring portion 182 has two sheets respectively passing through the second portion of the elastic arm 132 and the third portion of the elastic arm 132, and the blocking portion 183 is connected between the two sheets of the ring portion 182 at the side away from the plug 130. The elongated portion 184 is connected to the ring portion 182. In some embodiments, the elongated portion 184 is elongated in a direction (e.g., z-direction). The tab portion 186 is connected to the elongated portion 184. In a usage scenario, a user can drag the tab portion 186 along a direction away from the plug 130, so that the ring portion 182 drives the elastic arm 132 to rotate counterclockwise relative to the plug 130, as shown in FIG. 3.

In a usage scenario, the user can insert the plug 130 into the port. As the plug 130 inserts into the port, since the second portion (i.e., inclined portion) and the third portion (i.e., the portion extending to the free end) of the elastic arm 132 interfere with the port, the elastic arm 132 rotates counterclockwise relative to the plug 130 without pulling the pull tab 180. Next, as the plug 130 is fully accommodated in the port, the elastic arm 132 elastically recovers to the original position and is engaged with an inner surface of the port. As the plug 130 unplugs from the port, the user can drag the tab portion 186 along a direction away from the plug 130 (e.g., negative z-direction), so that the ring portion 182 drives the elastic arm 132 to rotate counterclockwise relative to the plug 130, thereby detaching the elastic arm 132 from the port. Next, as the user continues to drag the tab portion 186 of the pull tab 180, the ring portion 182 brings the plug 130 away from the port, so that the plug 130 is detached from the port.

From the above detailed description of the specific embodiments of the present disclosure, it can be clearly seen that in the cable assembly of the present disclosure, since the cable assembly includes the transition board connected between the second cable and the third cable, and the first terminal set and the second terminal set are connected to the plug via the first cable, the second cable, and the third cable, the first cable and the second cable can directly attach to the first terminal set and the second terminal set, respectively, thereby achieving the purpose of eliminating the influence of PCB trace loss. In addition, the cable assembly of the present disclosure also solves the problem of the removed space of the electrical component on the circuit board by the transition board.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A cable assembly, comprising:
a plug;
a circuit board module comprising a circuit board and a connecting port secured on and electrically connected to the circuit board;
a terminal holder secured with the circuit board, comprising a long groove and a short groove;
a first terminal set disposed in the long groove;
a second terminal set disposed in the long groove;
a third terminal set disposed in the short groove, electrically connected with the connecting port;
a first cable set connecting the first terminal set with the plug; and
a second cable set, comprising:
a transition board;
a second cable electrically connecting the second terminal set to the transition board; and
a third cable electrically connecting the transition board to the plug.

2. The cable assembly of claim 1, wherein the terminal holder comprises a first end portion and a second end portion on opposite sides of the terminal holder, and the first end portion is fixed on the circuit board by a fixing part.

3. The cable assembly of claim 2, wherein the second end portion of the terminal holder does not contact with the circuit board.

4. The cable assembly of claim 2, wherein the second end portion of the terminal holder is fixed on the circuit board by another fixing part.

5. The cable assembly of claim 1, wherein the third terminal set is electrically connected to the connecting port via the circuit board.

6. The cable assembly of claim 1, wherein a transmission speed of first terminal set is higher than that of the second terminal set and the third terminal set.

7. The cable assembly of claim 1, wherein a transmission speed of the first cable is higher than that of the second cable and the third cable.

8. The cable assembly of claim 1, wherein a width of an end of the first cable connected to the first terminal set is greater than a width of an end of the second cable connected to the second terminal set, and a width of an end of the first cable connected to the plug is greater than a width of an end of the third cable connected to the plug.

9. The cable assembly of claim 1, further comprising a pull tab connected to the plug.

10. The cable assembly of claim 9, wherein the plug comprises an elastic arm extending from the plug, wherein a fixed end of the elastic arm is connected to the plug and a free end of the elastic arm is suspended relative to the plug, and wherein the pull tab is connected to the elastic arm.

11. A cable assembly, comprising:
a plug;
a terminal holder, comprising:
a long groove, wherein a first terminal set and a second terminal set are disposed therein; and
a short groove, wherein a third terminal set is disposed therein;
a first cable set, comprising:
a first cable connected between the first terminal set and the plug; and
a second cable set, comprising:
a transition board including an electrical component;
a second cable electrically connecting the second terminal set to the transition board; and
a third cable electrically connecting the transition board to the plug.

12. The cable assembly of claim 11, wherein the terminal holder comprises a first end portion and a second end portion on opposite sides of the terminal holder.

13. The cable assembly of claim 12, further comprising a fixing part fixed on the second end portion.

14. The cable assembly of claim 12, wherein the short groove is located at a side of the terminal holder close to the first end portion and the long groove is located at a side of the terminal holder close to the second end portion.

15. The cable assembly of claim 11, wherein the third terminal set is not connected to the first cable set and the second cable set.

16. The cable assembly of claim 11, wherein a transmission speed of the first terminal set is higher than that of the second terminal set and the third terminal set.

17. The cable assembly of claim 11, wherein a transmission speed of the first cable is higher than that of the second cable and the third cable.

18. The cable assembly of claim 11, wherein a width of an end of the first cable connected to the first terminal set is greater than a width of an end of the second cable connected to the second terminal set, and a width of an end of the first cable connected to the plug is greater than a width of an end of the third cable connected to the plug.

19. The cable assembly of claim 11, further comprising a pull tab connected to the plug.

20. The cable assembly of claim 19, wherein the plug comprises an elastic arm extending from the plug, wherein a fixed end of the elastic arm is connected to the plug and a free end of the elastic arm is suspended relative to the plug, and wherein the pull tab is connected to the elastic arm.
